(19) United States
(12) Patent Application Publication
(10) Pub. No.: US 2023/0291289 A1
(43) Pub. Date: Sep. 14, 2023

(54) SELECTIVE NITRIDED LAMINATIONS FOR HIGH EFFICIENCY MOTORS

(71) Applicant: BorgWarner, Inc., Auburn Hills, MI (US)

(72) Inventors: Yumin Wang, Ithaca, NY (US); Dennis Bubel, Ithaca, NY (US); Brad Chamberlin, Pendleton, IN (US)

(21) Appl. No.: 17/692,443

(22) Filed: Mar. 11, 2022

(51) Int. Cl. H02K 15/03; H02K 1/276

(52) U.S. Cl. CPC H02K 15/03; H02K 1/2766

(57) ABSTRACT

Targeted cold working and nitriding is added to specific spots to decrease flux in bridge areas of motor steel laminations to alter the electromagnetic properties of these areas to reduce flux loss and increase the efficiency by using insulations coatings on the lamination steels as a nitriding barrier. The reduction in flux allows for the use of smaller magnets, which decreases costs and results in an increase in performance.

### BACKGROUND

The present invention relates to rotor assemblies of high efficiency motors, and more specifically to rotor assemblies with selectively nitride laminations to reduce flux.

Reducing the flux loss to increase the motor efficiency or increase the output of the motor without increasing the size of the motor is an ongoing challenge for electric and hybrid vehicles.

In a rotating electric machine, alternating current (AC) power is supplied to stator windings, to generate a rotating magnetic field. As the stator of such a rotating electric machine, there is a known structure in which terminals of segment coils are welded and connected. Coils are wound around a stator. A rotating electric machine supplies AC power to the coils, to cause the coils to generate a rotating magnetic field. A rotor is rotated by this rotating magnetic field to produce mechanical output power. Also, the mechanical energy applied to the rotor can be converted into electric energy, and AC power can be output from coils of the stator winding. In this manner, the rotating electric machine functions as an electric motor or a generator.

Conventionally, the motor laminations of the rotor are made of steel that has an insolation coating (C5).

### SUMMARY

According to one embodiment of the present invention, targeted nitriding is added to specific spots to decrease flux in bridge areas of motor steel laminations to alter the electromagnetic properties of these areas to reduce flux loss and increase the efficiency by using insulations coatings on the lamination steels as a nitriding barrier. The reduction in flux allows for the use of smaller magnets, which decreases costs and results in an increase in performance.

According to another embodiment of the present invention, a method to reduce the flux loss in motor laminations is disclosed. In a first step, insulation coating is locally removed in the desired areas during the lamination forming process. Next, laminations are nitrided to achieve selectively nitriding local areas in separated lamination configurations or stacked in a nitriding heat treating furnace.

### BRIEF DESCRIPTION OF THE DRAWINGS

FIG. 1 shows an example of a single rotor lamination.

FIG. 2 shows a graph of auxiliary magnetic field versus magnetic flux density after applying direct current.

FIG. 3 shows another graph of auxiliary magnetic field versus magnetic flux density after applying direct current.

FIG. 4 shows a graph of auxiliary magnetic field versus magnetic flux density after applying alternating current.

FIG. 5 shows an alternate magnet grouping.

FIG. 6 shows an individual magnet slot grouping piece.

FIG. 7 shows an alternative single rotor lamination with an insert.

FIG. 8 shows a schematic of an electric motor's stator and rotor.

FIG. 9 shows a close up view of a portion of the stator.

FIG. 10 shows another single rotor lamination with an insert.

### DETAILED DESCRIPTION

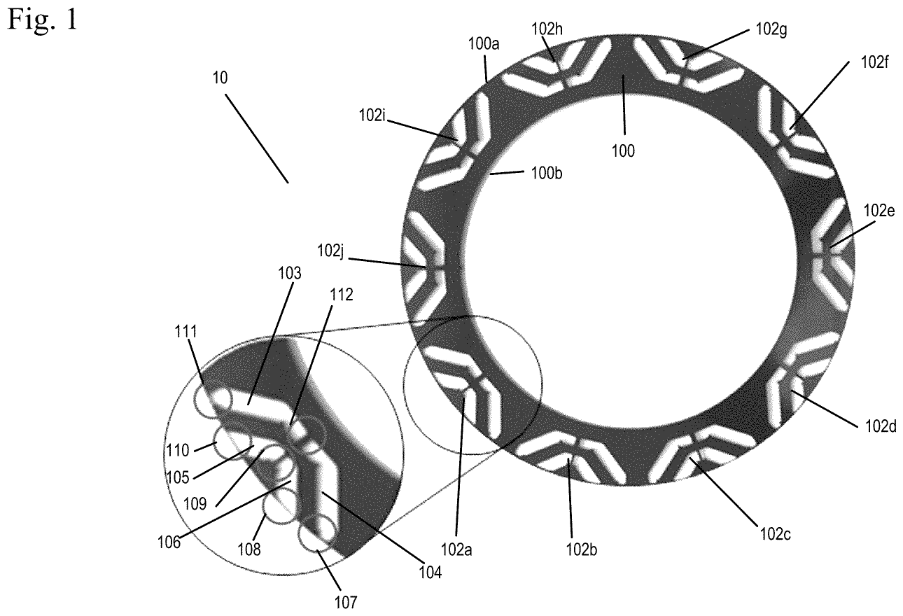

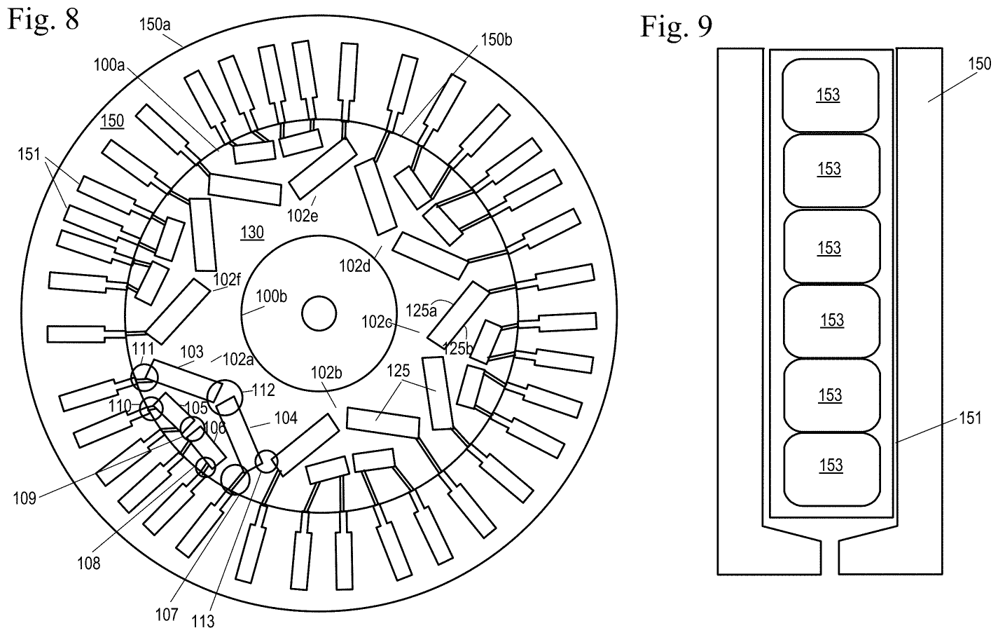

Motor laminations form the core of an electric motor's stator and rotor as shown in FIGS. 8-9 with a single rotor lamination shown in FIG. 1. They consist of thin metal sheets that are stacked, welded, and/or bonded together. Making the stator 150 and rotor 130 from individual pieces of metal rather than a solid pieces, reduces eddy current losses. The stator 150 typically consists of a plurality of steel laminations and can resemble a cylindrical core having an outer circumference 150a and an inner circumference 150b with evenly-spaced slots 151 for its phase windings or electromagnets 153. The motor laminations are made from cobalt-iron alloys, nickel alloys, silicon steel or thin-gauge electrical steel.

FIG. 1 shows an example of a single rotor lamination 10 of the rotor 130. The single rotor lamination 10 has a ring shaped body 100 having an outer circumferential edge 100a and an inner circumferential edge 100b. Along the body 100, between the inner and outer circumferential edges 100a, 100b are a plurality of magnet slot groupings 102a-102j each containing a plurality of magnet slots 103-106 and bridge regions 107-112 between the magnet slots 103-106 and an outer circumferential edge 100a. Each magnet slot 103-106 contains one or more magnets 125. Each magnet 125 has two poles 125a, 125b.

More specifically, bridge region 111 is between the outer circumferential edge 100a and a first magnet slot 103. Bridge region 107 is between the outer circumferential edge 100a and a second magnet slot 104. Bridge region 108 is between the outer circumferential edge 100a and the fourth magnet slot 106. Bridge region 109 is between the third magnet slot 105 and the fourth magnet slot 106. Bridge region 110 is between the outer circumferential edge 100a and the third magnet slot 105. Between the first and the second magnet slots 103, 104 is bridge region 112. The bridge region thickness should be as small or thin as possible while still maintaining the structural integrity of the rotor during operation of the motor.

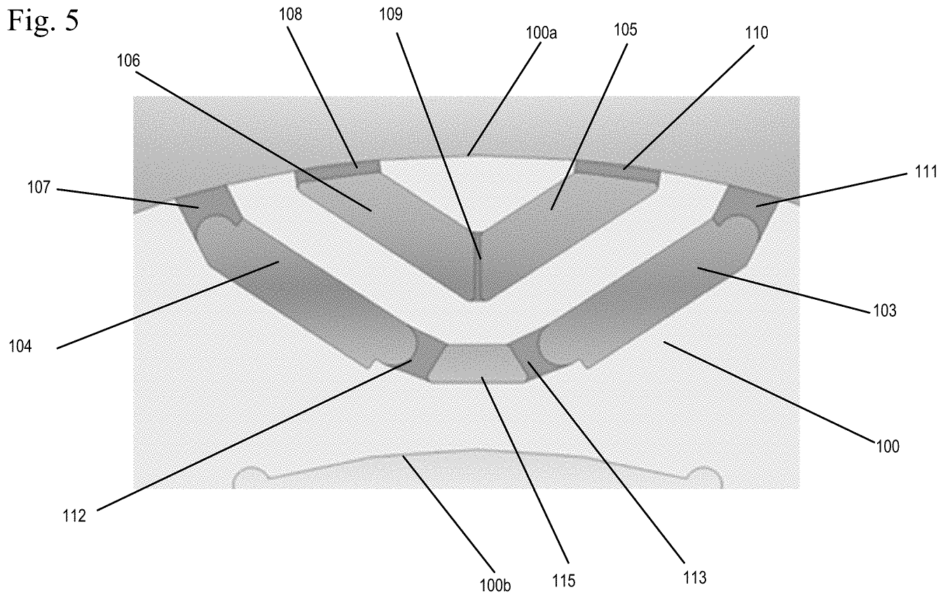

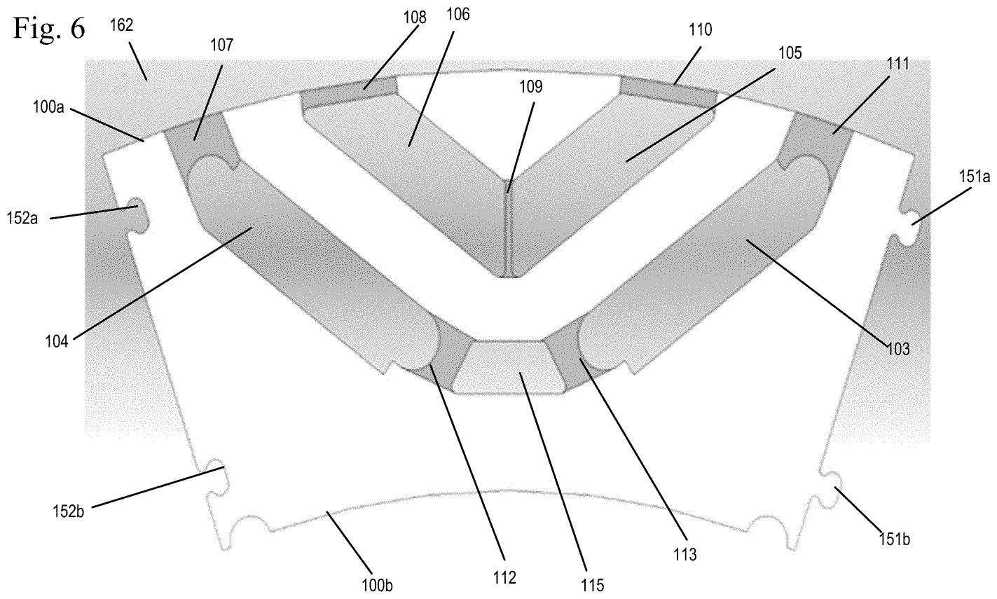

The layout of the magnet slots 103-106 is an example and can be altered within the scope of the art. For example, an additional magnet slot 115 can be present between the first magnet slot 103 and second magnet slot 104 as shown in FIGS. 5-6, such that a bridge region 112 is then present between magnet slot 115 and the second magnet slot 104 and another bridge region 113 is present between magnet slot 115 and the first magnet slot 103. The bridge regions 107-113 provide structural strength to the rotor lamination 10 and/or magnet to aid in holding the rotor lamination 10 together. The bridge regions 107-113 allow for flux leakage around the magnets 125 within the magnet slots 103-106 which reduces the magnetic field strength and are also the areas of the highest cyclical stress and the regions which are the first to fail in the rotor lamination 10. If flux leaks around the magnet 125, the flux is not reacting with the magnet 125 to generate a force, causing the torque to decrease. The more flux directed through the magnet 125 of the magnet slots 103-106, the higher the force, and the more torque generated. It is noted that due to the thinness of the bridge regions 107-112, the bridge region 107-113 can be saturated in flux, thus limiting the amount of flux that can go through a particular bridge region 107-113.

The magnets slots 103-106 are preferably as far radially outward as possible for a given rotor outer diameter (e.g. away from the outer circumference 100a) to maximize torque production of the motor, as torque equals force times distance. Therefore, the further out the slots 103-106, the greater the distance, and the more torque for a given force. The reaction between the magnets 125 within the magnet slots 103-106 and the magnetic field generated in the stator 150 create the force. It is noted that there is a relationship between the magnet slot 103-106 placement within the rotor lamination 10 for a given rotor outer diameter 100a and the structural strength at the bridge regions 107-112 between the magnet slots 103-106 to keep the rotor lamination 10 from breaking.

Embodiments of the present invention reduce magnetic flux leakage through the lamination of bridge regions 107-113 while maintaining the structural integrity of the lamination to improve power density.

In one embodiment, the bridge regions 107-113 of the rotor laminations undergo cold working. Some or all of the bridge regions can undergo cold working. The amount of bridge regions 107-113 which undergo cold working can vary depending on the application and the amount of flux to be focused through the magnets 125 of the magnet slots 103-106. The more bridge regions 107-113 which receive cold working, the more flux focused through the magnets 125 of the magnet slots 103-106.

Cold working strengthens metal by changing its shape without the use of heat and more specifically, is conducted at temperatures below the metal's recrystallization point by applying mechanical stress. Subjecting the metal to the mechanical stress causes a permanent change to the metal's crystalline structure, causing an increase in strength. The cold work is preferably coining, although other types of cold working can be used. For example, cold working can take place in a progressive stamping tool or as a subsequent process. If the cold working occurs within the progressive stamping tool, the cold working of the rotor laminations 10 takes place either before or after the magnet slots 103-106 are produced. For example, cold working of the rotor lamination 10 prior to forming of the magnet slots 103-106 would require removing a portion of the cold worked area after the magnet slots 103-106 are stamped.

In another embodiment, the bridge regions 107-113 are nitrided. Nitriding is a heat-treating process that diffuses nitrogen into the surface of a metal to create a case-hardened surface. Nitriding can either be carried out on the finished laminated stack forming the rotor 130 or on the individual laminations 10.

Selective nitriding in an embodiment of the present invention nitrides the bridge areas 103-113 of motor steel laminations to alter the electromagnetic properties of the areas to reduce the flux loss and increase the efficiency by using the insulation coatings or modified insulation coatings on the lamination steels as a nitriding barrier. The commonly used insulation coating C5 on the commercial lamination steels or modification coating acts as a nitriding barrier that prevent the steel underneath to be nitrided, while the surfaces where the coating is removed or not coated will be nitrided, in return reduced the magnetic properties of the lamination steel. Nitriding with the coating on the lamination does not change the magnetic properties. Thus, reducing the flux loss in motor laminations is achieved by locally removing the insulation coating in the desired areas during lamination forming process, then the laminations are nitrided to achieve selectively nitriding local areas either in separated lamination configuration or stacked in a nitriding heat treating furnace. In other words, the nitriding is specific areas force the flux to travel through the magnets 125.

In another embodiment, the bridge regions 107-113 are cold worked and then nitrided.

In yet another embodiment, individual rotor lamination segments are each comprised of a plurality magnet slot grouping pieces 162 which are individually constructed and pieced together to form a singular, circular, rotor lamination. The plurality of magnet slot grouping pieces 162 can be interconnected by a lock and key or dovetail assembly of pins 151a, 151b and sockets 152a, 152b. Pin 151a, adjacent the outer circumferential edge 100a can be received within a socket 152a of an adjacent individual magnet slot grouping piece 162 and the pin 151b, adjacent the inner circumferential edge 100b can be received within a socket 152b of an adjacent individual magnet slot grouping piece 162. By crafting individual rotor lamination segments, less waste material is generated and small die sets can be used. An example of an individual rotor lamination segment is shown in FIG. 6. In each of the magnet slot groupings, the bridge regions are treated with cold working or nitriding as described above.

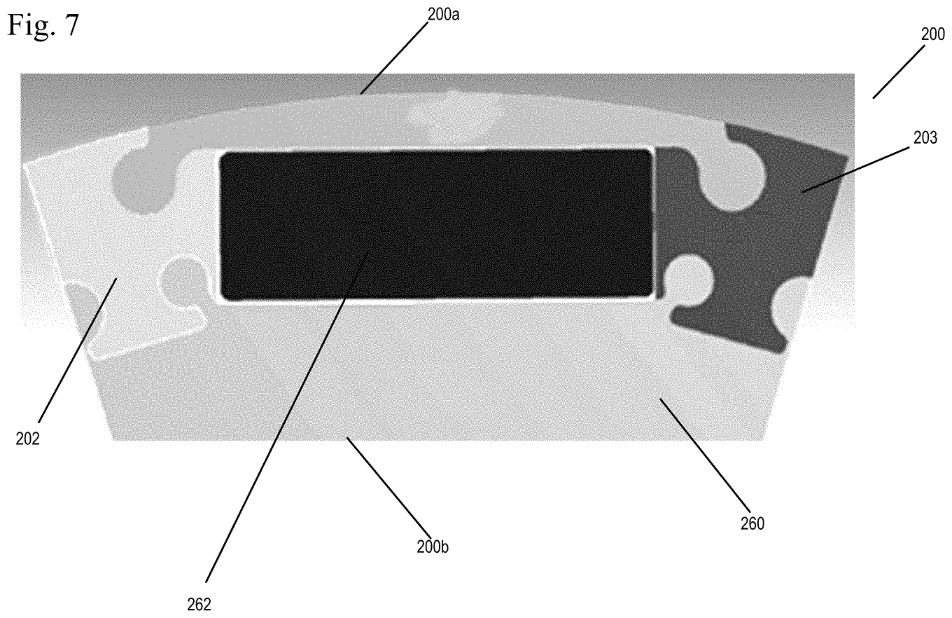

FIG. 7 shows another alternate embodiment in which inserts are within the rotor lamination. In this embodiment, the single rotor lamination 200 is a ring with a body 260 made of magnetic steel having an outer circumferential edge 200a and an inner circumferential edge 200b. Along the body 260, between the inner and outer circumferential edges 200a, 200b are a plurality of non-magnetic steel inserts 202, 203 spaced apart a distance. A magnet 262 is present between the insert 202 and insert 203 along the circumference of the single rotor lamination 200. In this arrangement, the non-magnetic steel inserts 202, 203 have lower magnetic flux density properties which replicate nitrided or cold worked regions in previous embodiments. The non-magnetic steel inserts 202, 203 keep the flux from going around either side of the magnet 262 and force the flux instead to go through the magnet 262.

In yet another embodiment, the insert pieces 202, 203 could be by non-magnetic and nitriding can be applied to the insert pieces areas of the single rotor lamination to additionally force the flux to travel through the magnet 262.

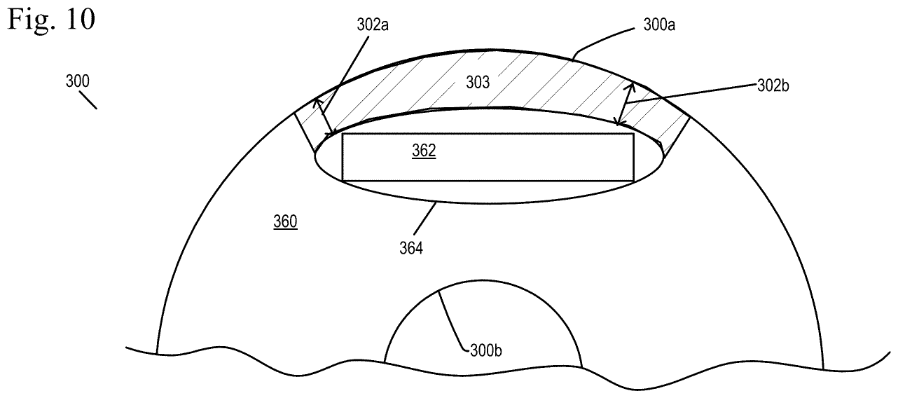

FIG. 10 shows another alternate embodiment in which a magnet 362 is present within a slot 364 formed within a single rotor lamination 300. In this embodiment, the single rotor lamination 300 is a ring with a body 360 made of magnetic steel having an outer circumferential edge 300a and an inner circumferential edge 300b. Within the body 360 is a slot 364 for receiving one or more magnets 362. One or more bridge regions 302a, 302b are present between the slot 364 and the outer circumferential edge 300a of the body 360 of the single rotor lamination 300. Therefore, in one embodiment, the entire region 303 (shown by hashed area) between the outer circumference 300a of the body 360 of the rotor lamination 300 and the slot 364 can be a bridge region or alternatively, one or more individual portions 302a, 302b of the region 303 between the slot 364 and the outer circumferential edge 300a of the body 360 of the single rotor lamination 300 can be a bride region. Another bridge region can additionally be present between the slot 364 and the inner circumferential edge 300b of the body 360 of the rotor lamination 300. Any or all of the bride regions 302a, 302b, 303 preferably undergoes cold working or nitriding as described above.

Manufacturing

The rotor laminations are each produced by progressive stamping of steel slit coil which is automatically fed into a progressive die.

Cold working can take place in a progressive stamping tool or as a subsequent process. If the cold working occurs within the progressive stamping tool, the cold working of the rotor laminations 10 takes place either before or after the magnet slots 103-106 are produced. For example, cold working of the rotor lamination 10 prior to forming of the magnet slots 103-106 would require removing a portion of the cold worked area after the magnet slots 103-106 are stamped.

The entire circumference of the rotor lamination can be created through the progressive stamping as single rotor lamination or alternatively pieces comprising the circumference of the single rotor lamination can be created and pieced together after stamping to form the single rotor lamination. For example, FIG. 6 shows a piece of the rotor lamination that is connected to other pieces to form a circumference of a single rotor lamination.

After the completed rotor lamination parts are removed from the progressive die, the parts are cleaned and dried.

Nitriding can either be carried out on the finished laminated stack forming the rotor 130 or on the individual laminations 10.

At least some of the rotor laminations are aligned and adhered together. The adherence of the single rotor laminations together can take place though various means, for example by adhesives, welding, mechanical fit, interlocking etc . . . .

### Example 1

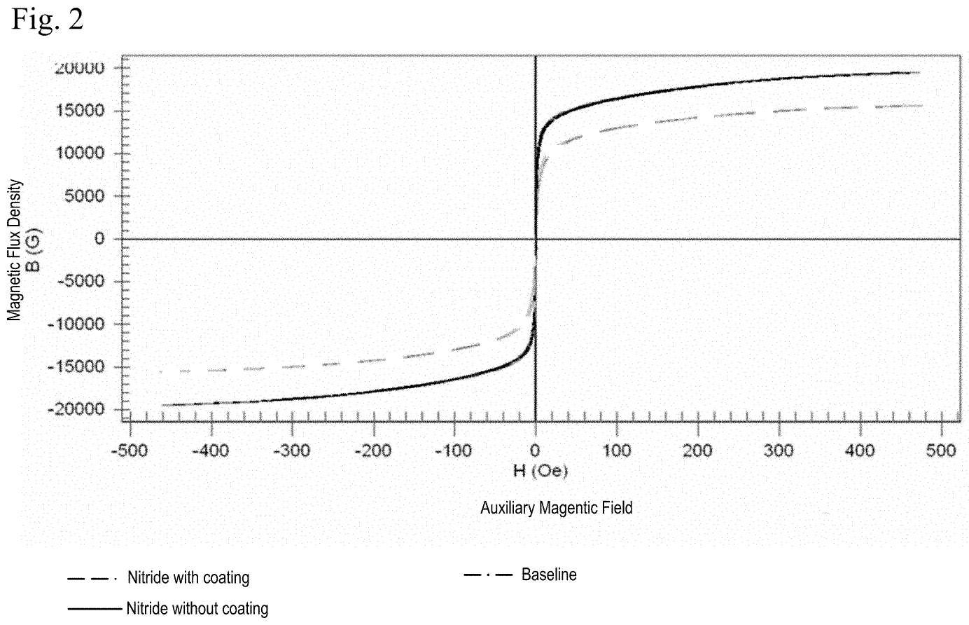

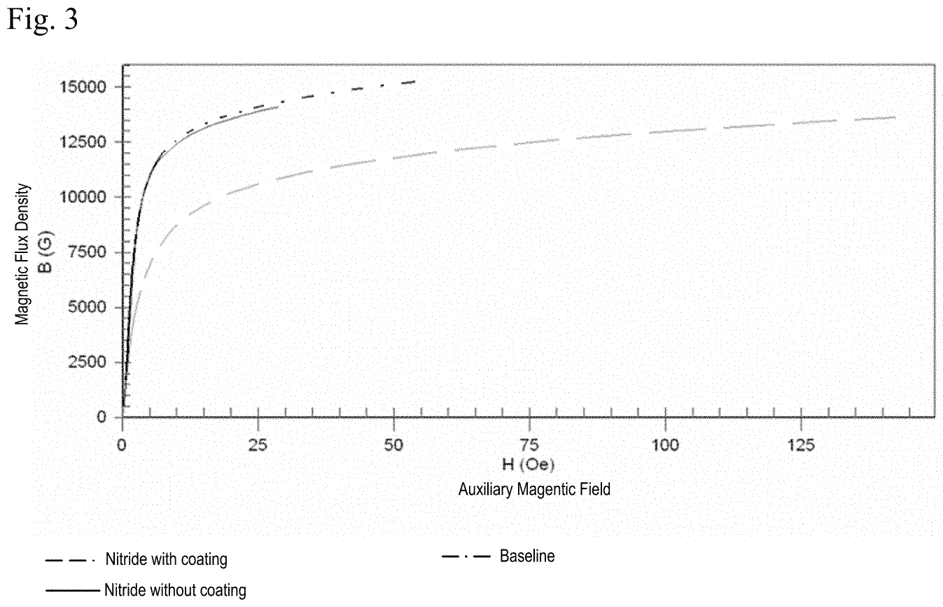

To test the effectiveness of the cold working or nitriding the bridge regions of the rotor laminations, a wind toroid and test base-line toroid were constructed. Magnetic flux density testing was performed. Direct current (DC) was conducted through a first toroid without nitriding or coating, a second toroid with nitriding and a coating, such as C5, and a third toroid with nitriding, but no coating. As shown in FIGS. 2-3, the third toroid without any coating or nitriding and the second toroid with nitriding and coating have a higher magnetic flux density from −500 to 500 Hertz within the auxiliary magnetic field than the first toroid with only nitriding.

### Example 2

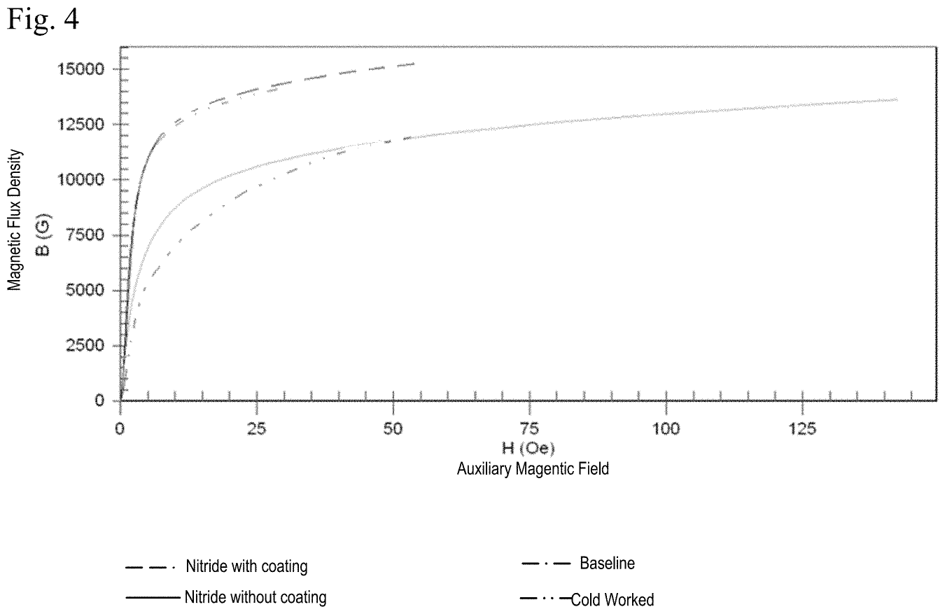

Alternating current (AC) was also conducted through the first toroid without nitriding or coating, a second toroid with nitriding and a coating, such as C5, a third toroid with nitriding, but no coating, and a fourth toroid with cold working up to 200 Hertz (Hz). As shown in FIG. 4, within the auxiliary magnetic field H, less than 43 oersted (Oe), the magnetic flux density was lower for the fourth toroid including cold work than the first, second or third toroids. Greater than 43 Oe, the fourth toroid had approximately the same magnetic flux density as the first toroid with nitriding and no coating. Based on the test results: cold working of the toroid reduced the magnetic properties of the lamination steel; nitriding a toroid with the coating removed reduced the magnetic properties of the lamination steel; and nitriding and coating the toroid did not change the magnetic properties of the lamination steel.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of decreasing flux leakage of a rotor lamination, the rotor lamination comprising a body having a ring shape with an outer circumferential edge and an inner circumferential edge; a plurality of magnet groupings, each magnet grouping comprising: a plurality of magnet slots of at least a first magnet slot and a second magnet slot, each containing a magnet with a first pole and a second pole; a first bridge region between the first magnet slot and the outer circumferential edge; a second bridge region between the second magnet slot and the outer circumferential edge; and a third bridge region between the first magnet slot and the second magnet slot; the method comprising:
applying cold working to at least one of the first bridge region, the second bridge region, or the third bridge.

2. The method of claim 1, wherein the magnetic grouping further comprises at least a third magnet slot, a fourth magnet slot; a fourth bridge region between the third magnet slot and the outer circumferential edge; a fifth bridge region between the fourth magnet slot and the outer circumferential edge; and a sixth bridge region between the third magnet slot and the fourth magnet slot and nitriding is applied to at least one of the first bridge region, the second bridge region, the third bridge region, the fourth bridge region, the fifth bridge region and the sixth bridge region.

3. The method of claim 2, further comprising removing an insulation coating from at least one of the first bridge region, the second bridge region, the third bridge region, the fourth bridge region, the fifth bridge region, and the sixth bridge region prior to applying nitriding to the at least one of the first bridge region, the second bridge region, the third bridge region, the fourth bridge region, the fifth bridge region and the sixth bridge region.

4. The method of claim 1, further comprising removing an insulation coating from at least one of the first bridge region, the second bridge region, and the third bridge region prior to applying nitriding to the at least one of the first bridge region, the second bridge region, and the third bridge region.

5. The method of claim 1, wherein the plurality of magnet groupings are formed within magnet slot grouping pieces which are interconnected to form a singular, circular rotor lamination.

6. The method of claim 1, wherein the cold working is coining.

7. The method of claim 1, wherein the nitrided or cold worked first bridge region, second bridge region, and third bridge region force flux through the magnets within the plurality of magnet slots.

8. A method of decreasing flux leakage of a rotor lamination, the rotor lamination comprising a body having a ring shape with an outer circumferential edge and an inner circumferential edge; a plurality of magnet groupings between the outer circumferential edge and the inner circumferential edge, each magnet grouping comprising: a plurality of magnet slots of at least a first magnet slot, a magnet having a first pole and a second pole within each of each of the at least first magnet slots, and a plurality of bridge regions of at least a first bridge region between either of the first pole or second pole of the magnet in the at least first magnet slot and the outer circumferential edge, the method comprising:
applying one of either cold working or nitriding to the at least the first bridge region.

9. The method of claim 8, wherein the magnet grouping further comprising: a second magnet slot having another magnet; a second bridge region between the second magnet slot and the outer circumferential edge and a third bridge region between the first magnet slot and the second magnet slot and applying one of either cold working or nitriding to the second bridge region or the third bridge region.

10. The method of claim 9, wherein the magnetic grouping further comprises at least a third magnet slot, a fourth magnet slot each containing a magnet; a fourth bridge region between the third magnet slot and the outer circumferential edge; a fifth bridge region between the fourth magnet slot and the outer circumferential edge; and a sixth bridge region between the third magnet slot and the fourth magnet slot and nitriding is applied to at least one of the first bridge region, the second bridge region, the third bridge region, the fourth bridge region, the fifth bridge region and the sixth bridge region.

11. The method of claim 10, further comprising removing an insulation coating from at least one of the first bridge region, the second bridge region, the third bridge region, the fifth bridge region, and the sixth bridge region prior to applying nitriding to the at least one of the first bridge region, the second bridge region, the third bridge region, the fourth bridge region, the fifth bridge region and the sixth bridge region.

12. The method of claim 8, further comprising removing an insulation coating from at least one of the first bridge region.

13. A rotor lamination comprising:
a body having a ring shape with an outer circumferential edge and an inner circumferential edge;
a plurality of magnet groupings between the outer circumferential edge and the inner circumferential edge, each magnet grouping comprising:
a plurality of magnet slots of at least a first magnet slot;
a magnet having a first pole and a second pole within each of the plurality of magnet slots; and
at least one of a bridge region being cold worked or nitrided, the bridge region comprising a first bridge region between the first magnet slot and the outer circumferential edge;
wherein the at least one bridge region being cold worked or nitrided decrease flux leakage of the rotor lamination.

14. The rotor lamination of claim 13, further comprising a second magnet slot, a second bridge region between the second magnet slot and the outer circumferential edge and a third bridge region between the first magnet slot and the second magnet slot.

15. The rotor lamination of claim 14, wherein the magnetic grouping further comprises at least a third magnet slot, a fourth magnet slot; a fourth bridge region between the third magnet slot and the outer circumferential edge; a fifth bridge region between the fourth magnet slot and the outer circumferential edge; and a sixth bridge region between the third magnet slot and the fourth magnet slot.

16. The rotor lamination of claim 13, wherein the plurality of magnet groupings are formed within magnet slot grouping pieces which are interconnected to form a singular, circular rotor lamination.

17. The rotor lamination of claim 16, wherein the magnet slot groupings are interconnected through dovetail pins and sockets.

18. The rotor lamination of claim 13, wherein the body is magnetic steel.

19. A rotor lamination comprising:
a magnetic body having a ring shape with an outer circumferential edge and an inner circumferential edge;
a plurality of magnets around a circumference of the body between the outer circumferential edge and the inner circumferential edge; and
a plurality of non-magnetic inserts between each of the plurality of magnets;
wherein the plurality of non-magnetic inserts force flux to pass through the plurality of magnets.
